(19) United States
(12) Patent Application Publication
(10) Pub. No.: US 2006/0054261 A1
(43) Pub. Date: Mar. 16, 2006

(54) Pneumatic tire and method of manufacturing the same

(76) Inventors: Takashi Fukutomi, Hiratsuka-shi (JP); Satoshi Makino, Wako-shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/542,573

(22) PCT Filed: Feb. 24, 2004
(86) PCT No.: PCT/JP04/02127

§ 371 Date: Jul. 19, 2005

(30) Foreign Application Priority Data
Feb. 27, 2003 (JP) 2003050291

(51) Int. Cl. B60C 9/02

(52) U.S. Cl. 152/548

(57) ABSTRACT

A pneumatic tire capable of eliminating the need of repairing puncture on the outside of a car and effectively preventing air leakage without accompanying an increase in weight and deterioration of riding comfortableness which occur in a conventional punctureless tire and a method of manufacturing the pneumatic tire, the pneumatic tire characterized in that a rubber-like thin-film formed of a latex dry thin-film in which 20 to 50 wt % rubber component is liquid isoprene rubber and having a breaking elongation of 900% or more and a tensile strength of 15 MPa or higher is disposed on the inner surface of the tire.

### TECHNICAL FIELD

The present invention relates to a pneumatic tire suitable as a so-called punctureless tire. More specifically, the present invention relates to a pneumatic tire having an excellent puncture prevention function while eliminating disadvantages of a conventional punctureless tire and relates to a method of manufacturing the same.

### BACKGROUND ART

Various technologies have heretofore been proposed as measures against puncture. A run-flat tire, for example, includes thick cushion rubber from a tread portion to sidewall portions, and the run-flat tire punctured allows driving about several hundred kilometers. However, once punctured, the run-flat tire cannot be repaired and reused. Moreover, the run-flat tire has a disadvantage that riding comfortableness in normal driving is impaired.

Another measure is a puncture repair liquid, which is a liquid repair agent and injected into a tire after the tire is punctured. The agent is then solidified and fills a hole. Such a puncture repair liquid is versatile and easy to use, but requires a work on the outside of a car when the tire is punctured. The puncture repair liquid is therefore unsuitable for use on a highway and the like.

Still another measure is a sealant tire in which a sealant (viscous composition) is previously disposed on the inner surface of the tire and automatically fills a hole formed when the tire is punctured (for example, see Japanese patent application Kokai publication No. Sho 53 (1978)-55802). However, in the sealant tire, it is required to dispose a thick sealant in order to obtain a sufficient effect. Thus, there is a disadvantage of an increase in weight. When the sealant is applied to the inner surface of the tire, it is required to remove a mold release agent attached to the inner surface of the tire. Thus, productivity is also poor.

### SUMMARY OF THE INVENTION

It is an object of the present invention to provide a pneumatic tire capable of eliminating the need of repairing puncture on the outside of a car and effectively preventing air leakage without accompanying an increase in weight and deterioration of riding comfortableness which occur in a conventional punctureless tire and to provide a method of manufacturing the pneumatic tire.

A pneumatic tire of the present invention to achieve the foregoing object is characterized in that a rubber-like thin-film is disposed on an inner surface of the tire, the rubber-like thin-film being formed of a latex dry thin-film in which 20 to 50 wt % rubber component is liquid isoprene rubber and having a breaking elongation of 900% or more and a tensile strength of 15 MPa or higher.

As described above, the rubber-like thin-film with a large breaking elongation and a large tensile strength is disposed on the inner surface of the tire. Accordingly, when a foreign object such as a nail enters into the tire or is removed from the tire, the rubber-like thin-film around a puncture hole can prevent air leakage. Moreover, the pneumatic tire including the rubber-like thin-film described above is not accompanied by an increase in weight and deterioration of riding comfortableness and eliminates the need of repairing puncture on the outside of a car.

The latex dry thin-film includes properties as described above and can be formed on the inner surface of the tire even in a state where a mold release agent is attached to the inner surface of the tire. Use of the latex in which 20 to 50 wt % rubber component is liquid isoprene rubber, in particular, makes it possible to give optimal adhesion and stretchability to the rubber-like thin-film, and to exert an excellent puncture prevention function for a foreign object having a thick and complicated shape such as a screw. Here, it is preferable that a molecular weight range of the liquid isoprene rubber is 20,000 to 40,000.

In the present invention, in order to prevent the increase in weight, it is preferable that a thickness of the rubber-like thin-film is 2.0 mm or less. In the case where the mold release agent is interposed between the rubber-like thin-film and the inner surface of the tire, the rubber-like thin-film is easily peeled off from the inner surface of the tire when the foreign object such as a nail enters into the tire. Accordingly, the air leakage can be prevented more effectively.

A method of manufacturing the pneumatic tire of the present invention utilizing the above-described characteristics of the latex is a method of manufacturing a pneumatic tire including a rubber-like thin-film on an inner surface of the tire, the rubber-like thin-film having a breaking elongation of 900% or more and a tensile strength of 15 MPa or higher. The method is characterized by including: pouring latex in which 20 to 50 wt % rubber component is liquid isoprene rubber into the tire vulcanized; and drying the latex while rotating the tire to form the rubber-like thin-film composed of a dry thin-film of the latex on the inner surface of the tire. According to the manufacturing method as described above, it is possible to easily form the rubber-like thin-film with a uniform thickness.

### BRIEF DESCRIPTION OF THE DRAWINGS

FIG. 1 is a meridian half sectional view showing a pneumatic tire according to an embodiment of the present invention.

FIG. 2 is a cross-sectional view showing a state where a nail sticks in a tread portion.

FIG. 3 is a cross-sectional view showing a state after the nail is removed from the tread portion.

### DESCRIPTION OF THE PREFERRED EMBODIMENT

With reference to the accompanying drawings, a constitution of the present invention will be described in detail below.

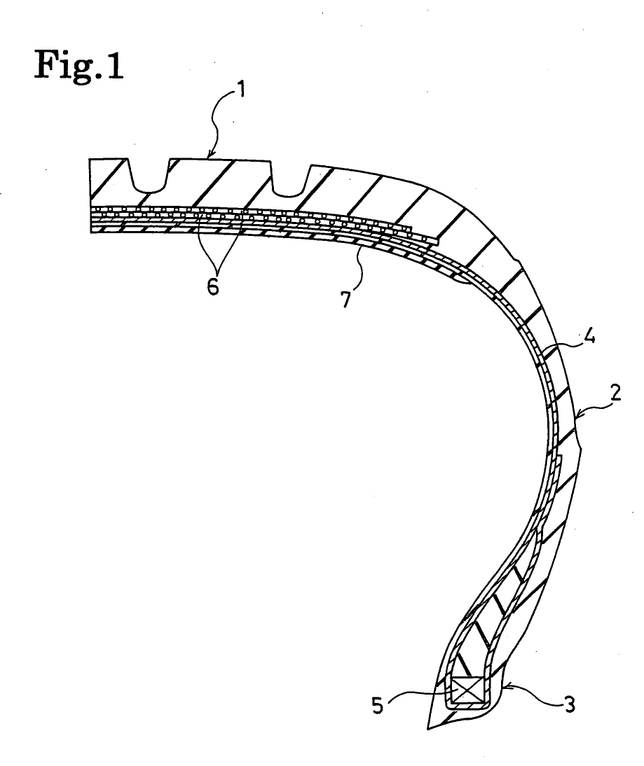

FIG. 1 shows a pneumatic tire according to an embodiment of the present invention. Reference numerals 1 to 3 denote a tread portion, a sidewall portion, and a bead portion, respectively. A carcass layer 4 is laid between the bead portion 3 and another bead portion 3 on the other side, and each end of the carcass layer 4 is folded around a bead core 5 from the inner side of the tire to the outer side of the tire. On the outer peripheral side of the carcass layer 4 in the tread portion 1, a plurality of belt layers 6 are buried.

In the above-described pneumatic tire, a rubber-like thin-film 7 with a breaking elongation of 900% or more, preferably, 900 to 1500%, and a tensile strength of 15 MPa or higher, preferably, 15 to 20 MPa, is disposed with a thickness of 2.0 mm or less in an area of an inner surface of the tire corresponding to the tread portion 1. The rubber-like thin-film 7 may be disposed not only in the area of the inner surface of the tire corresponding to the tread portion 1 but also in an area of the inner surface of the tire corresponding to the sidewall portion 2 and the bead portions 3.

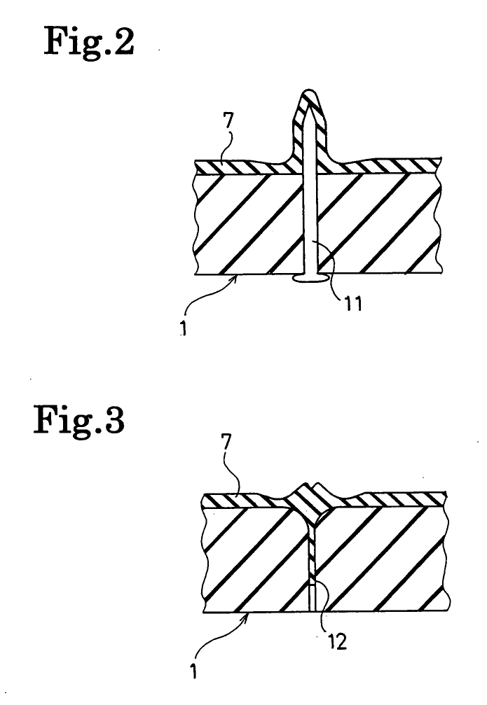

When a foreign object such as a nail 11 sticks in the tread portion 1 and enters into the tire, as shown in FIG. 2, the rubber-like thin-film 7 described above is peeled off from the inner surface of the tire and clings to the foreign object such as the nail 11 to prevent air leakage. When the breaking elongation and the tensile strength of the rubber-like thin-film 7 are insufficient, the nail 11 or the like entering into the tire easily penetrates the rubber-like thin-film 7. Thus, a puncture prevention function does not work adequately.

On the other hand, when the foreign object such as the nail 11 is removed, as shown in FIG. 3, the rubber-like thin-film 7 covers a puncture hole 12 and prevents air leakage. When the foreign object such as the nail 11 is removed, in particular, the rubber-like thin-film 7 clinging to the foreign object is bunched up into a ball to effectively cover the puncture hole 12.

When a thickness of the rubber-like thin-film 7 exceeds 2.0 mm, a weight of the tire is significantly increased, and characteristics of the tire are changed, which is not preferable. It is preferable that a lower limit of the thickness of the rubber-like thin-film 7 is 0.1 mm, and the thickness thereof is selected within a range of 0.1 to 2.0 mm.

The rubber-like thin-film 7 is formed to have a uniform thickness by pouring latex having fluidity arbitrarily controlled into a normal product tire and drying the latex while gradually rotating the tire. As for the latex, it is necessary to use latex in which 20 to 50 wt % rubber component is liquid isoprene rubber. Here, it is preferable that a molecular weight range of the liquid isoprene rubber is 20,000 to 40,000. Such liquid isoprene rubber increases tack of the rubber-like thin-film 7. When the liquid isoprene rubber is less than 20 wt % of the rubber component, the tack of the rubber-like thin-film 7 is insufficient. Accordingly, air leakage could be caused, for example, when a screw sticks in the tire. On the contrary, when the liquid isoprene rubber exceeds 50 wt % of the rubber component, elasticity of the rubber-like thin-film 7 is reduced, leading to inadequate sealability. The other rubber component of the latex is, preferably, natural rubber latex but may be synthetic rubber, such as styrene-butadiene rubber (SBR), emulsified and dispersed in water. Moreover, in the latex rubber, a filler such as carbon black and various compounding ingredients may be added when needed.

When the rubber-like thin-film 7 is composed of a latex dry thin-film, it is not required to remove a mold release agent used in vulcanization from the inner surface of the tire. In the case where the mold release agent is interposed between the rubber-like thin-film 7 and the inner surface of the tire, the rubber-like thin-film 7 is easily peeled off from the inner surface of the tire when the foreign object such as the nail enters into the tire. Thus, the air leakage can be prevented more effectively. As the mold release agent described above, it is preferable to use a silicone-based agent. Table 1 shows an example of a composition of a silicone-based mold release agent. In Table 1, silicone emulsion contains 40 wt % silicone. The total content of mica and talc is 45 to 55 wt %. The preservative and the antifoaming agent are optionally added.

TABLE 1

| (Weight %) | Typical Example | Range |
|---|---|---|
| Silicone emulsion | 18 | 15-20 |
| Mica (muscovite or | 35 | 30-40 |
| sericite) | | |
| Talc | 15 | 10-20 |
| Thickener | 0.2 | 0.1-0.4 |
| (carboxymethyl | | |
| cellulose) | | |
| Preservative | 0.2 | 0.1-0.4 |
| Antifoaming agent | 0.01 | 0.01-0.02 |
| (silicone-based) | | |
| Water | remainder | remainder |

Although the preferred embodiment of the present invention has been described in detail above, it should be understood that various modifications, replacements, and substitutions can be made without departing from the spirit and the scope of the present invention as defined by the appended claims.

### EXAMPLES

Pneumatic tires of a conventional example, examples 1 and 2, and comparative examples 1 to 3 having the same size of 205/65R15 were produced. In the pneumatic tire of the conventional example, a sealant was applied to an area of an inner surface of the tire corresponding to a tread portion as a puncture prevention layer. In each of the pneumatic tires of the examples 1 and 2 and the comparative examples 1 to 3, a rubber-like thin-film composed of a latex dry thin-film was disposed as a puncture prevention layer in an area of an inner surface of the tire corresponding to a tread portion.

In the conventional example, a thickness of the sealant including polyisobutylene blended with polybuten was 4 mm. In the examples 1 and 2 and the comparative examples 1 to 3, the rubber-like thin-films with a thickness of 1.0 mm were formed of natural rubber latex and liquid isoprene rubber latex in various blending ratios.

For each of these test tires, a weight of the sealant or the rubber-like thin-film disposed on the inner surface of the tire was measured, and sealability was evaluated. Table 2 shows the results. The results of the weight measured are indicated by indices based on the weight of the conventional example set to 100. A smaller index means that the tire is lighter. The sealability was evaluated by use of ten tires for each of the cases where a N65 nail specified by JIS penetrates the tread portion of each tire and where a screw with a diameter of 4.5 mm penetrates the tread portion of each tire. In the former case, an initial internal pressure of each tire was set to 200 kPa, and the N65 nail was allowed to penetrate the tread portion of the tire and then removed. After the tire was left for 24 hours, and the internal pressure of the tire was measured again. In the latter case, an initial internal pressure of each tire was set to 200 kPa, and the screw was allowed to penetrate the tread portion of the tire and then removed. After the tire was left for 24 hours, the internal pressure of the tire was measured again. In either case, tires of which internal pressure was maintained at 95% or more of the initial internal pressure were passed. The evaluation results show the number of tires passed.

TABLE 2

| | Conventional | Example | Example | Comparative | Comparative | Comparative |
|---|---|---|---|---|---|---|
| | Example | 1 | 2 | Example 1 | Example 2 | Example 3 |
| Puncture | sealant | rubber- | rubber- | rubber-like | rubber-like | rubber-like |
| prevention layer | | like | like | thin-film | thin-film | thin-film |
| | | thin- | thin- | | | |
| | | film | film | | | |
| NR latex (wt %) | — | 80 | 50 | 100 | 90 | 40 |
| Liquid IR latex | — | 20 | 50 | 0 | 10 | 60 |
| (wt %) | | | | | | |
| Thickness (mm) | 4 | 1 | 1 | 1 | 1 | 1 |
| Braking | — | 1080 | 1080 | 1050 | 1100 | 920 |
| elongation (%) | | | | | | |
| Tensile strength | — | 16.8 | 15.9 | 17.5 | 17.0 | 14.2 |
| (MPa) | | | | | | |
| Sealability | | | | | | |
| N65 | 10/10 | 10/10 | 10/10 | 10/10 | 10/10 | 10/10 |
| nail | | | | | | |
| screw | 10/10 | 9/10 | 10/10 | 4/10 | 6/10 | 3/10 |
| Weight (index) | 100 | 82 | 82 | 82 | 82 | 82 |

As is clear from Table 2, the pneumatic tires of the examples 1 and 2 have a puncture prevention function as excellent as that of the conventional example and have a smaller increase in weight. On the other hand, the puncture prevention function of the pneumatic tires of the comparative examples 1 and 2 does not work adequately when the screws penetrate. Examination of the cause thereof reveals that adhesion of the rubber-like thin-films to the screws is insufficient. Moreover, the puncture prevention function of the pneumatic tire of the comparative example 3 does not work adequately when the screw penetrates. Examination of the cause thereof reveals inadequate formation of a ball covering a puncture hole when the screw is removed.

### INDUSTRIAL APPLICABILITY

The present invention can be effectively utilized in tire manufacturing industries and thus in automobile manufacturing industries.

1. A pneumatic tire, comprising:
a rubber-like thin-film disposed on an inner surface of the tire, the rubber-like thin-film being formed of a latex dry thin-film in which 20 to 50 wt % rubber component is liquid isoprene rubber and having a breaking elongation of not less than 900% and a tensile strength of not lower than 15 MPa.

2. The pneumatic tire according to claim 1, wherein a thickness of the rubber-like thin-film is not more than 2.0 mm.

3. The pneumatic tire according to claim 1, wherein a molecular weight range of the liquid isoprene rubber is 20,000 to 40,000.

4. The pneumatic tire according to claim 1, wherein a mold release agent is interposed between the rubber-like thin-film and the inner surface of the tire.

5. A method of manufacturing a pneumatic tire including a rubber-like thin-film on an inner surface of the tire, the rubber-like thin-film having a breaking elongation of not less than 900% and a tensile strength of not lower than 15 MPa, the method comprising:
poring latex in which 20 to 50 wt % rubber component is liquid isoprene rubber into the tire vulcanized; and
drying the latex while rotating the tire to form the rubber-like thin-film composed of a dry thin-film of the latex on the inner surface of the tire.

6. The method of manufacturing a pneumatic tire according to claim 5, wherein a thickness of the rubber-like thin-film is not more than 2.0 mm.

7. The method of manufacturing a pneumatic tire according to claim 5, wherein a molecular weight range of the liquid isoprene rubber is 20,000 to 40,000.

8. The method of manufacturing a pneumatic tire according to claim 5, wherein a mold release agent is interposed between the rubber-like thin-film and the inner surface of the tire.
